(19) United States
(12) Patent Application Publication
(10) Pub. No.: US 2009/0192658 A1
(43) Pub. Date: Jul. 30, 2009

(54) Vehicle Guidance System and Method

(76) Inventor: Paul E. Wofford, JR., New Market, AL (US)

Correspondence Address: LANIER FORD SHAVER & PAYNE P.C., P O BOX 2087, HUNTSVILLE, AL, 35804-2087, US

(21) Appl. No.: 12/019,475

(22) Filed: Jan. 24, 2008

(51) Int. Cl. G06F 17/00; B62D 15/02

(52) U.S. Cl. 701/2; 701/1; 701/41

(57) ABSTRACT

A vehicle guidance system in accordance with the present disclosure has a transmitter for transmitting information related to a movement of a vehicle to a receiver and logic configured to determine how to steer a vehicle so as to align the vehicle with an object, the logic further configured to provide the information to the transmitter.

### BACKGROUND OF THE INVENTION

### Background

Oftentimes drivers desire to back up a vehicle to an object for various reasons. For example, the driver may desire to hook a boat trailer or a cargo trailer up to the vehicle for towing. As another example, the driver may desire to back up the vehicle to the vicinity of cargo for loading in the vehicle itself.

If the driver is alone and desiring to engage in such activity, it is often difficult to gage the distance from the object to the vehicle or the location of the object with respect to the vehicle. If the driver is not alone, a second individual may stand outside the vehicle, shout commands, and provide hand signals to the driver in an attempt to guide the driver to the desired location.

### SUMMARY OF THE INVENTION

Generally, the present invention provides a vehicle guidance system and method for guiding a vehicle to an object.

A vehicle guidance system in accordance with an exemplary embodiment of the present disclosure has a transmitter for transmitting to a receiver information related to a movement of a vehicle and logic configured to determine how to steer a vehicle so as to align the vehicle with an object, the logic further configured to provide the information to the transmitter. A vehicle guidance method in accordance with an exemplary embodiment of the present invention can be broadly conceptualized by the following steps of: 1) determining information related to how to steer a vehicle so as to align the vehicle with an object; 2) transmitting the information to a receiver; and 3) relaying the information to a driver of the vehicle.

### BRIEF DESCRIPTION OF THE DRAWINGS

The invention can be better understood with reference to the following drawings. The elements of the drawings are not necessarily to scale relative to each other, emphasis instead being placed upon clearly illustrating the principles of the invention. Furthermore, like reference numerals designate corresponding parts throughout the several views.

FIG. 1 is a block diagram illustrating an exemplary vehicle guidance system in accordance with an embodiment of the present disclosure.

FIG. 2 is a diagram illustrating an exemplary control box as depicted in FIG. 1.

FIG. 3 is a block diagram depicting the components of FIG. 2 for detecting direction and distance.

FIG. 4 is a block diagram of an exemplary controller for the system depicted in FIG. 1.

FIG. 5 is a block diagram illustrating another embodiment of a vehicle guidance system in accordance with an embodiment of the present disclosure.

FIG. 6 is a block diagram of an exemplary controller for the system depicted in FIG. 5.

FIG. 7 is a flowchart depicting exemplary functionality of a controller of FIG. 4 or FIG. 6.

### DETAILED DESCRIPTION OF THE INVENTION

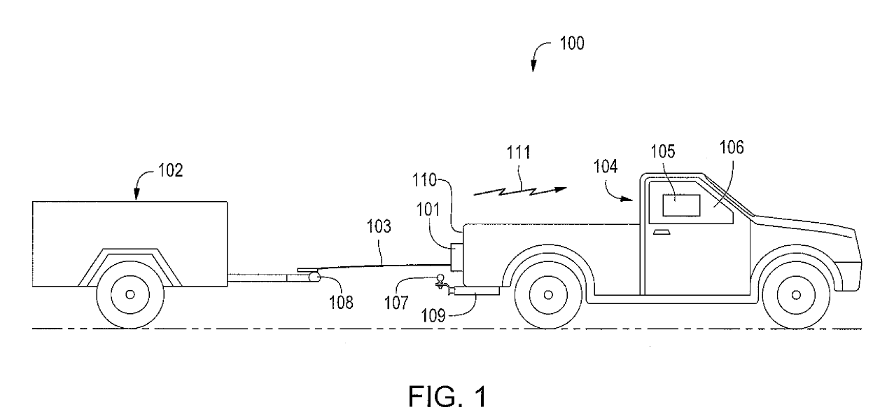

FIG. 1 depicts an exemplary embodiment of a vehicle guidance system 100 in accordance with an embodiment of the present disclosure. The system 100 comprises a control box 101 and a receiving unit 105. The control box 101 is affixed to a vehicle 104, and the receiving unit 105 is within a cabin 106 of the vehicle 104.

In one embodiment, receiving unit 105 is a radio (not shown) within the cabin 106. The receiving unit 105 may be portable or installed within the cabin 106. In another embodiment, the receiving unit 105 may be a separate unit from the radio within the cabin 106. This unit may be part of the console instrument cluster (not shown).

Furthermore, the control box 101 may be permanently or temporarily affixed to the vehicle 104, e.g., bolted to the vehicle 104 or slidably coupled to the vehicle 104 so that it can be removed easily. The control box 101 may be affixed to the bumper 109 or to the tailgate 110 of the vehicle 104. In one embodiment, the control box 101 would be centered about the hitch 107 of the vehicle 104.

The control box 101 comprises a retractable cable 103. The retractable cable 103 is extended by a driver (not shown) and removably coupled to an object with which to align the vehicle 104. Such an object could be a trailer 102. The trailer 102 may be, for example, a utility trailer, a boat trailer, a horse trailer, a camper, or a cargo trailer.

During operation, the driver would first power on the control box 101. The driver then extends the retractable cable 103, and removably affixes the cable 103 to the trailer 102. In one embodiment, the driver affixes the cable 103 to a point on the trailer 102 to with which the driver desires to align his vehicle. For example, if the driver desires to backup the vehicle so that he can attach the hitch 108 of the trailer 102 with the hitch 107 of the vehicle 104, the driver would removably attach the cable 103 on or near the hitch 108. In one embodiment, if the control box 101 is affixed to vehicle 104 off center of the hitch 107, then the retractable cable 103 has to be removably coupled off center of the trailer's hitch 108 the same amount.

The driver gets into the cabin 106 of the vehicle 104 and powers on his vehicle 104 and the receiving unit 105, which can be the radio in the vehicle 104. Note that the control box 101 is configured to transmit a signal at a selectable frequency, e.g., an example frequency of 88.1 Mega hertz with Frequency Modulation (FM) could be used. Thus, if the receiving unit 105 is tuned “88.1 FM,” then the receiving unit 105 will receive the signal from the control box 101.

The receiving unit 105 relays the information contained in the signal to the driver of the vehicle 104. Note that “relay” refers to communicating to the driver the information contained in the signal. Thus, the receiving unit 105 may generate an audible representation of the signal that is heard by the driver. In another embodiment, the receiving unit 105 may generate a digital representation of the signal that is visually generated so that the driver can read the information on, for example, a liquid crystal display (LCD).

In operation, the control box 101 calculates a distance between the trailer 102 and the vehicle 104. Once the distance is calculated, the control box 101 transmits a radio signal 111, which is modulated to contain a digitally-generated verbal representation of the distance calculated.

The receiving unit 105, which is tuned to the frequency of the radio signal 111, receives the signal 111. The receiving unit 105 relays the digitally-generated verbal representation as directions/information for the driver. For example, if the vehicle 104 is twenty-five feet from the trailer 102, the receiving unit 105 would relay “twenty-five feet back.”

In addition, the control box 101 determines the direction of the angular displacement of the vehicle 104 from the trailer 102. Once the direction is calculated, the control box 101 transmits a radio signal 111, which is modulated to contain a digitally-generated verbal representation of the direction the driver should turn the vehicle 104 to better align the vehicle 104 with the trailer 102.

The receiving unit 105, which is tuned to the frequency of the radio signal 111, receives the signal 111. The receiving unit 105 relays the digitally-generated verbal representation as directions/information for the driver. For example, if the trailer 102 is misaligned behind the vehicle 104, the receiving unit 105 relays specific directions as to movement of the vehicle 104 so as to align the vehicle 104 with the trailer 102, e.g., “right . . . right . . . right” or “left . . . left . . . left,” accordingly.

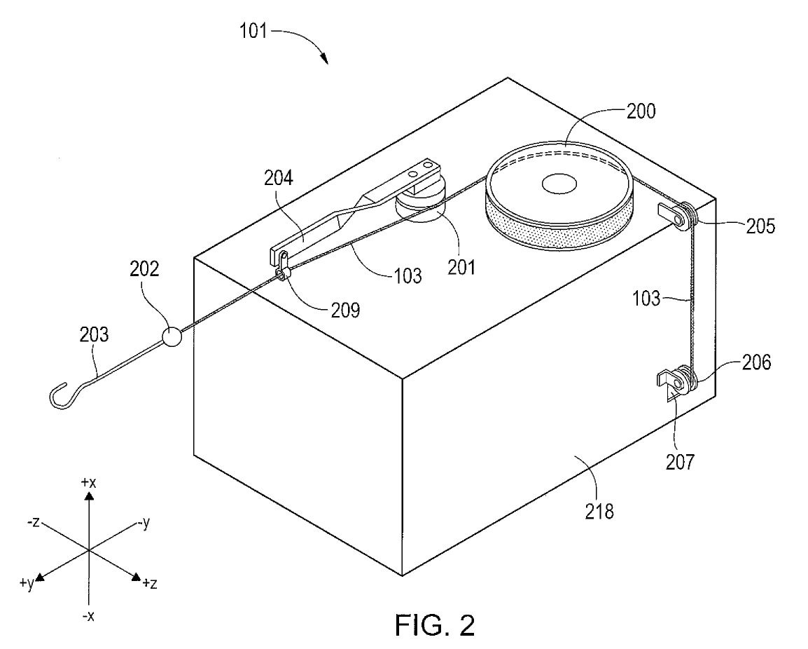

FIG. 2 depicts an exemplary control box 101 as depicted in FIG. 1. The control box 101 further comprises an upper fixed cable guide 205 and a lower fixed cable guide 206. The upper guide 205 guides the cable 103 to the cable guide 206, which interfaces with an opening 207 in the control box 101. The cable guide 206 guides the cable from the control box 101 via the opening 207.

Note that the cable guides 205 and 206 are shown in the exemplary embodiment in FIG. 2, however, the cable guides 205 and 206 may not be used in other embodiments or more than two cable guides may be used in other embodiments.

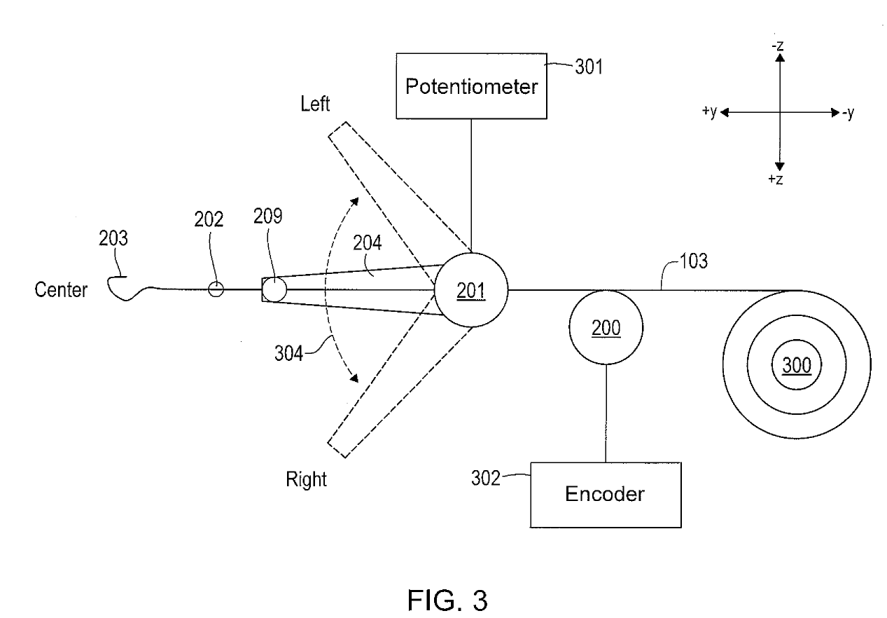

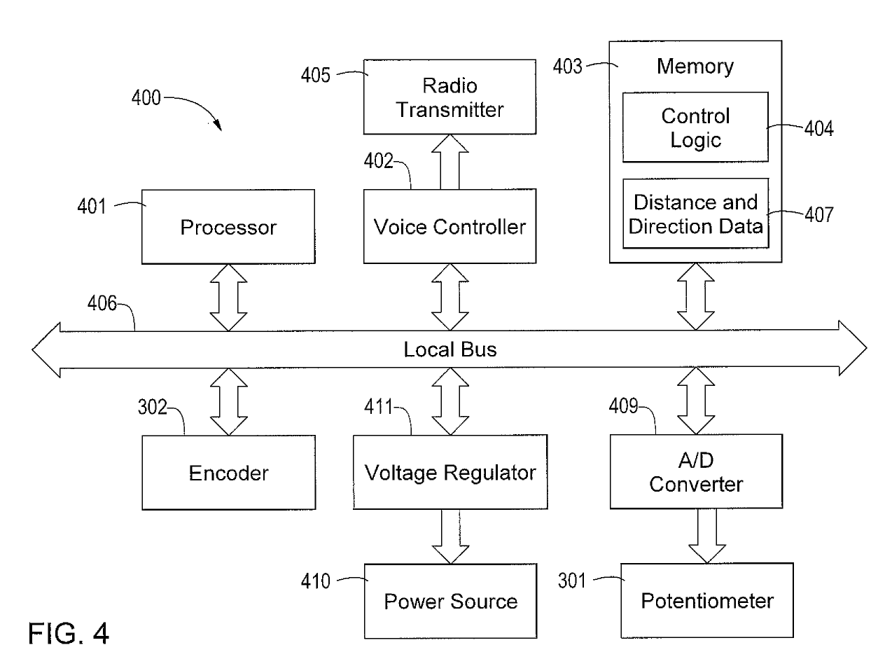

The control box 101 further comprises a roller 200 that interfaces with the cable 103. When the cable 103 moves horizontally in the + or −Y direction, i.e., extending or retracting cable 103, the roller 200 rotates. Thus, the movement of the roller 200 is related to the distance that the cable 103 has been extended and/or retracted, which is discussed further herein with reference to FIGS. 3 and 4.

Additionally, the control box 101 comprises a pivoting cylinder 201. The pivoting cylinder 201 is coupled to a first end of an arm 204, and the arm 204 is coupled at its opposing end to a guide 209 that slidably retains the cable 103. Note that the pivoting cylinder 201, the arm 204, and the guide 209 are not coupled to the control box 101. Thus, if the cable 103 moves horizontally in the ±z direction, the arm 204 is angularly displaced and rotates the pivoting cylinder 201 to relate movement to the left/right, which is described further with reference to FIG. 3.

In one embodiment, the cable 103 is retained by a spring-loaded reel (not shown) fixedly attached within a housing 218 of the control box 101. The spring-loaded reel limits the amount of cable 103 that can be extended to the length that is retained by the reel. Thus, the cable 103 does not extend too far through the guide 209 in the +y direction.

Furthermore, the control box 101 comprises a stop 202 that is fixed to the cable 103. The stop 202 ensures that the cable 103 does not retract too far through the guide 209 in the −y direction.

In addition, the cable 103 is attached to a connector 203. The connector 203, for example, can be a hook or a magnetic device that attaches the cable 103 to the trailer 102. In one embodiment, the connector 203 can be removably attached to the trailer 102 (FIG. 1) or object with which to align the vehicle 104.

FIG. 3 is a block diagram depicting operational components of the control box 101. In this regard, the cable 103 is part of a retractable reel 300 of cable. The reel 300 of cable may be retained within the housing 218 (FIG. 2) or on top of the housing 218 where the roller 200 and pivoting cylinder 201 are located. In the embodiment shown in FIG. 2, the reel 300 is within the housing 218.

The cable 103 interfaces with the roller 200 and the pivoting cylinder 201 and is attached to a trailer 102 (FIG. 1) via the connector 203. Note that the stop 202 is connected to the cable 103 and keeps the cable 103 from being springedly reeled in by the reel 300 through the guide 209.

The roller 200 is mechanically and rotatably coupled to an encoder 302. The encoder 302 may be contained within the control box 101 (FIG. 2). In addition, the pivoting cylinder 201 is coupled to a potentiometer 301. The potentiometer 301 may also be contained within the control box 101.

Note that the encoder 302 is a sensor that converts linear and/or rotary motion into digital data. In one embodiment, the Encoder 302 is a quadrature encoder or sometimes referred to as an incremental encoder. This type of encoder is known for its' ability to determine distance and direction of travel. This encoder generates a “quadrature” signal which translates into four states. Transition from one state to the next is well defined so that with software and/or control logic, direction and distance traveled can be determined.

By knowing the direction of roller 200, the control box 101 can know whether the vehicle 104 (FIG. 1) is moving toward or away from the trailer 102 (FIG. 1).

Further note that the potentiometer 301 comprises a variable resistor (not shown) that is used to detect angular displacement indicated by reference arrow 304. In this regard, as the voltage changes across the variable resistor, this change indicates the angular movement of the arm 204.

As an example, the potentiometer 301 may have a range of 0 to 5 Volts. The potentiometer 301 could be calibrated for zero at 2.5 Volts. Thus, any thing above 2.5 Volts would indicate that the arm 204 has moved to the left of “center” along the reference arrow 304, whereas anything below 2.5 Volts would indicate that the arm 204 has moved to the right of center along the reference arrow 304. Movement to the right by the arm 204 would indicate that the trailer 102 is to the right of the vehicle 104, and movement to the left by the arm 204 would indicate that the trailer 102 is to the left of the vehicle 104.

Therefore, the angular movement by the arm 204 is translated from voltage changes produced by the potentiometer 301, detected by the A/D converter 409 and control logic 404. This alignment data is used to determine the need for vehicle alignment to the left or right.

FIG. 4 depicts a block diagram of a controller 400 that may be utilized in the control box 101 (FIG. 1) to control the system 100. The controller 400 may be, for example, a printed circuit board comprising one or more of the elements shown.

The controller 400 preferably comprises memory 403, which stores control logic 404. The control logic 404 can be hardware, software, Field Programmable Gate Array (FPGA) code, or any combination thereof.

In one embodiment, the control logic 404 is executed via one or more processors 401, such as a central processing unit (CPU), for example, which communicates to and drives the other elements within the controller 400 via a local bus 406, which can include one or more buses.

The controller 400 further comprises a voice controller 402, a radio transmitter 405, and voltage regulators 411. In addition, the controller 400 comprises the encoder 302 and the potentiometer 301, as described with reference to FIGS. 2 and 3. The voice controller 402 can be controlled by the control logic 404 and the processor 401 over the local bus 406, and the radio transmitter 405 receives analog signals from the voice controller 402 indicative of commands related to movement of the vehicle 104 relevant to the trailer 102.

The controller 400 comprises a power source 410, which is regulated by voltage regulators 411. Notably, the voltage regulator 411 may step the voltage down from 12 Volts to the voltages needed by the controller 400, e.g., 5 Volts.

In one embodiment, the power source 410 is a battery (not shown) of the vehicle 104 (FIG. 1). In such an embodiment, the controller 400 comprises a trailer pigtail (not shown), which when connected to vehicle 104 trailer mating pigtail (not shown), will obtain power from the running lights connection. This connection is normally used to power the running lights of the trailer 102 (FIG. 1), e.g., the running lights of a trailer 102 that is attached to the vehicle 104.

In another embodiment, the power source 410 is a battery contained within the control box 101. If it is contained within the control box 101, the battery (not shown) would be a normal off-the-shelf battery, e.g., a 9 Volt battery.

The voice controller 402 may be any type of controller and/or processor known in the art that receives digital data and converts the data into an analog signal indicative of audible sound. In one embodiment the voice controller 402 is a processor that works in both “record” and “playback” modes. In record mode, (used only in manufacturing preparation of the voice controller) one can speak into a transducer (not shown), and the spoken words are stored as addressable data. In playback mode, one can pass an identifier, e.g., a physical memory address, to the voice controller 402, and the voice controller 402 produces an analog signal indicative of the recorded words at the addressed location to the radio transmitter 405.

As described hereinabove, the encoder 302 passes data to the control logic 404 indicative of the forward and/or backward direction and distance of the movement of the cable 103 (FIG. 3) relative to the object. Such change indicates the linear displacement of the vehicle 104 relative to the trailer 102. Furthermore, the potentiometer 301 passes analog data to an analog-to-digital converter 409 indicating the angle change over reference line 304 (FIG. 3) of the arm 204. Such change indicates the angular displacement of the vehicle 104 relative to the trailer 102.

During operation, the driver (not shown) powers on the control box 101. If the control box 101 is powered through the vehicle lights via the vehicle trailer pigtail, the control box 101 pigtail (not shown) is connected to the vehicle trailer pigtail and the vehicle lights are turned on by the driver to power the control box 101. If the control box 101 is powered by a self-contained battery (not shown), the driver may flip a power switch (not shown) on the control box 101 as the first step.

The driver attaches the cable 103 (FIGS. 1, 2, and 3) to the trailer 102 with which he wishes to align the vehicle 104. In one embodiment, the control logic 404 begins to operate when it is powered on. As described hereinabove, the roller 200 is communicatively coupled to the encoder 302, and the pivoting cylinder 201 is communicatively coupled to the potentiometer 301.

The control logic 404 calculates the distance between the vehicle 104 and the trailer 102 based upon the known circumference of the roller 200 and the rotational movement of the roller 200. Thus, the encoder 302 translates the initial distance to the trailer 102 based upon the movement and/or number of rotations made by the roller 200 when the cable 103 is extended to the trailer 102. The encoder 302 passes digital data indicative of the distance to the trailer 102 to the control logic 404, which the control logic 404 stores as distance data 407.

In addition to detecting the distance to the trailer 102, the encoder 302 also detects whether the roller 200 is moving in a direction that indicates that the vehicle 104 is driving away from or towards the trailer 102, i.e., in a +/−y direction. Notably, the +/−y direction of the cable 103 indicating away from or toward the trailer 102 can be communicated to the control logic 404 and stored as direction data 407. Note that the encoder 302 may be hardware, software, or a combination thereof, including, but not limited to a Field Programmable Gate Array (CPGA).

As described hereinabove, the cable 103 is attached to the pivoting cylinder 201 through a guide 209 at the end of the armature 204 fixedly attached to the pivoting cylinder 201. The pivoting cylinder 201 is communicatively coupled to the potentiometer 301, which may be a variable resistor, as described hereinabove.

As the armature 304 varies from its calibrated “center,” as described hereinabove, the voltage changes across the potentiometer 301, depending upon whether the armature moves to the right or left of center. This voltage drop is detected by the A/D converter 409. The AID converter 409 translates the voltage drop into digital data, and the control logic 404 determines whether the data indicates that the armature 204 is to the right or left of center, +/−z direction (FIG. 2).

If it is to the right of center, +z direction, this indicates that the coupling/aligning end of the vehicle 104 should be steered to the right to align with the trailer 102. Thus, the control logic 404 passes the data indicative of the phrase “right” to the voice controller 402. If it is to the left of center, −z direction, this indicates that the coupling/aligning end of the vehicle 104 should be steered to the left to align with the trailer 102. Thus, the control logic 404 passes the data indicative of the phrase “left” to the voice controller 402.

The voice controller 402 receives digital data indicating commands to be transmitted to the cabin 106 (FIG. 1) of the vehicle 104. The voice controller 402 uses the digital data received to retrieve and pass an analog signal indicating the requested command.

In one embodiment the control logic 404 passes digital data indicative of “left,” “right,” “backward,” and/or the distance to the trailer 102. The voice controller 402 receives the digital data, retrieves the analog signal previously recorded that will produce the audible words “left,” “right,” “backward,” and/or distance. The voice controller 402 passes the retrieved signals to the radio transmitter 405.

The radio transmitter 405 receives the analog signal comprising the data indicative of the direction and/or distance. Upon receipt, the radio transmitter 405 transmits a radio signal to the receiving unit 105 (FIG. 1). The receiving unit 105 relays the radio signal received in the form of verbal commands.

Therefore, while the driver is backing up, over the receiving unit 105 the driver can be told how far the vehicle 104 is from the trailer 102. In addition, the driver may be told whether he needs to steer left or right in order to better align with the trailer 102.

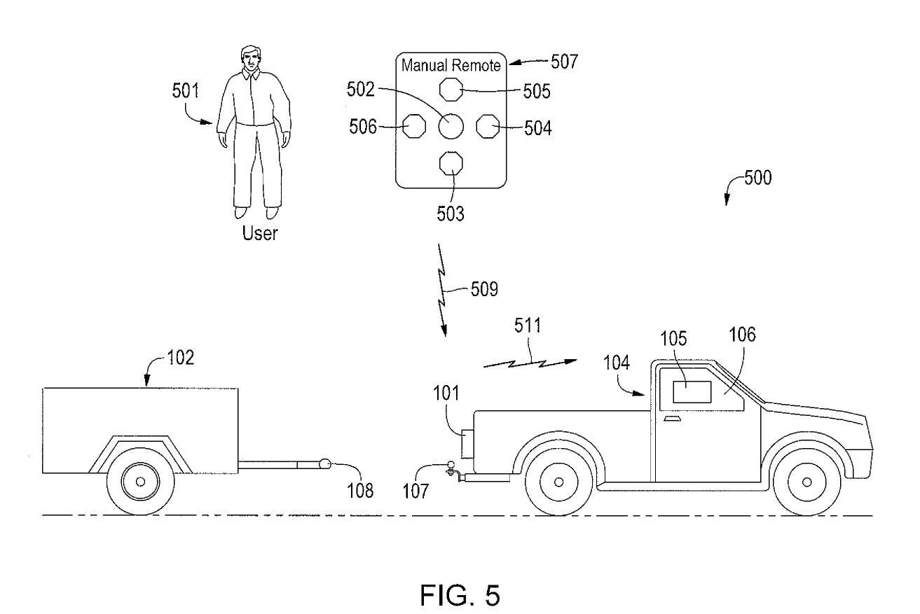

FIG. 5 depicts a system 500 in accordance with another embodiment of the present disclosure. The system 500 comprises a manual remote 507, the control box 101, and the receiving unit 105 within the cabin 106, similar to the system 100 depicted in FIG. 1.

However, in the system 500, a user 501 manually transmits, via a manual remote 507, data indicative of “left,” “right,” “backward,” or “stop” (hereinafter referred to as the “command data”) to the control box 101. Such data is transmitted in the form of a radio signal 509, for example, to the control box 101.

The control box 101 translates the command data into directions. Once the directions are known, the control box 101 transmits a radio signal 511, which is modulated to contain a digitally-generated verbal representation of the command the driver needs to execute with the vehicle 104 to better align the vehicle 104 with the trailer 102. The receiving unit 105, which is tuned to the frequency of the radio signal 511, receives the signal 511. The receiving unit 105 relays the digitally-generated verbal representation as directions/information to the driver (not shown) of the vehicle 104.

Thus, as the driver is backing up the vehicle 104 toward the trailer 102, the user 501 may select one of the buttons 502-506 that may be associated with one or more of the commands. The manual remote 507 transmits the signal 509 indicative of the command to the control box 101, which transmits it to the receiving unit 105, and the receiving unit 105 relays the command to the driver.

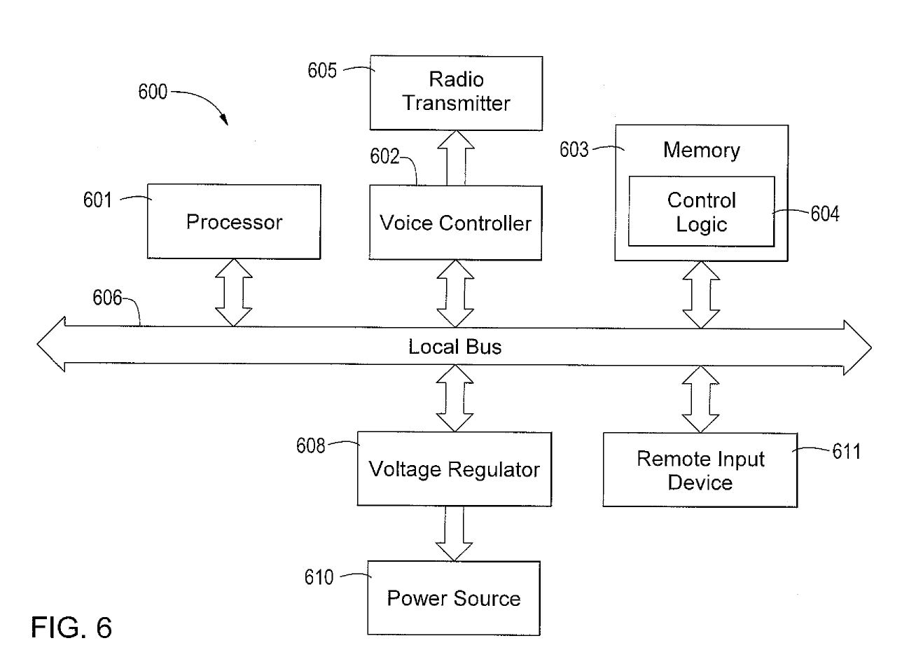

FIG. 6 depicts an exemplary controller 600 for the manual remote 500. The controller 600 preferably comprises memory 603, which stores control logic 604. The control logic 604 can be hardware, software or any combination thereof.

In one embodiment, the control logic 604 is executed via one or more processor 601, such as a central processing unit (CPU), for example, which communicate to and drive the other elements within the controller 600 via a local bus 606, which can include one or more buses.

The controller 600 further comprises a voice controller 602, a radio transmitter 605, voltage regulators 608, and remote input device 611. The voice controller 602 can be controlled by the control logic 604 and the processor 601 over the local bus 606, and the radio transmitter 605 receives analog signals from the voice controller 602 indicative of commands related to movement of the vehicle 104 (FIG. 1) relevant to the trailer 102 (FIG. 1).

Note that the controller 600 is substantially similar to the controller 400 depicted in FIG. 4. In this regard, a power source 610 and voltage regulator 608 are substantially similar to the power source 410 and the voltage regulator 411 depicted in FIG. 4. Thus, the power source 610 is regulated by voltage regulators 608. Notably, the voltage regulator 608 may step the voltage down from 12 Volts to the voltages needed by the controller 600, e.g., 5 Volts.

In addition, the voice controller 602 and the radio transmitter 605 are substantially similar to the voice controller 402 and the radio transmitter 405, respectively, described with reference to FIG. 4. In this regard, the voice controller 602 can be controlled by the control logic 604 and the processor 601 over the local bus 606, and the radio transmitter 605 receives analog signals from the voice controller 602 indicative of commands related to movement of the vehicle 104 relevant to the trailer 102.

The user 501 (FIG. 5) selects one of the buttons 502-506 (FIG. 5) on the manual remote 507 (FIG. 5), which represents a command. The manual remote 507 transmits a signal 509 to the control box 101 indicative of the button selected, which represents a command. The control logic 604 translates the selection, which is digital data, to one of a plurality of the pre-stored commands, and passes the digital data to the voice controller 602. The voice controller 602, in turn, passes a signal to the radio transmitter 605 indicative of the command selected by the user 501. The retrieval and transmission of analog signals indicative of commands is substantially similar to that which occurs as described with reference to FIG. 4

In this regard, the voice controller 602 receives digital data indicating commands to be transmitted to the cabin 106 (FIG. 5) of the vehicle 104. The voice controller 602 uses the digital data received to retrieve and pass an analog signal indicating the requested command.

In one embodiment, the control logic 604 passes digital data indicative of “left,” “right,” “backward,” and/or “stop” to the voice controller 602. The voice controller 602 receives the digital data, retrieves the analog signal previously recorded that will produce the audible words “left,” “right,” “backward,” and/or “stop.” The voice controller 602 passes the retrieved signals to the radio transmitter 605.

The radio transmitter 605 receives the analog signal comprising the data indicative of the direction and/or the command. Upon receipt, the radio transmitter 605 transmits a radio signal to the receiving unit 105 (FIG. 5). The receiving unit 105 relays the radio signal received in the form of verbal commands.

Therefore, while the driver is backing up, over the receiving unit 105 the driver can be told to continue moving in the current direction or stop. In addition, the driver may be told whether he needs to steer left or right in order to better align with the trailer 102.

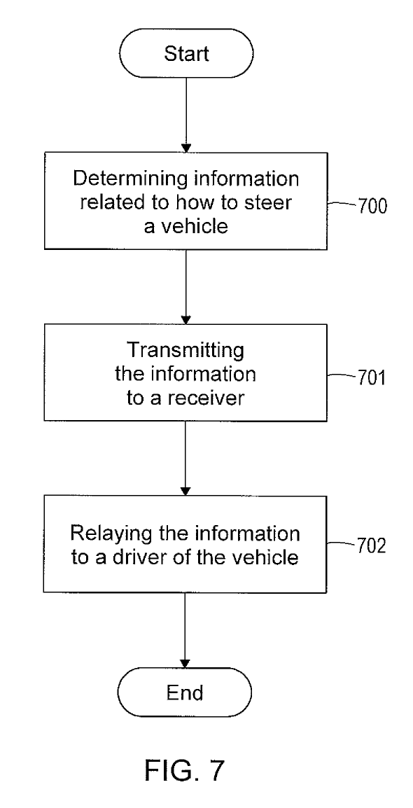

FIG. 7 is a flowchart depicting exemplary architecture and functionality of the control logic 404 (FIG. 4) and control logic 604 (FIG. 6).

In step 700, the control logic 404 and 604 determines a direction to steer a vehicle 104 (FIG. 1) so as to align the vehicle 104 with a trailer 102. This determination may be made via a control box 101 (FIG. 1) coupled to the bumper 109 (FIG. 1) of a vehicle 104 (FIG. 4) and a cable extended to the trailer 102. An encoder 302 (FIG. 3) can monitor a roller 200 (FIG. 2) and translate the movement or number of rotations of the roller 200 to a distance. In addition, the determination may be made by receiving a manual input via a remote 507 (FIG. 5).

The next step 701 is transmitting the information to a receiving unit 105 (FIG. 1). The receiving unit 105 may be a radio located in the cabin 106 (FIG. 1) of the vehicle 104

The receiving unit 105 then relays the information to a driver of the vehicle 104, as indicated in step 702.

Now, therefore, the following is claimed:

1. A vehicle guidance system, comprising:
a transmitter for transmitting information related to a movement of a vehicle to a receiver; and
logic configured to determine how to steer a vehicle so as to align the vehicle with an object, the logic further configured to provide the information to the transmitter.

2. The vehicle guidance system of claim 1, wherein the receiver relays the information to the driver.

3. The vehicle guidance system of claim 2, wherein the receiver audibly relays the information to the driver.

4. The vehicle guidance system of claim 2, wherein the receiver visually relays the information to the driver.

5. The vehicle guidance system of claim 1, wherein the information corresponds to a distance of the vehicle from the object.

6. The vehicle guidance system of claim 1, wherein the information corresponds to a location of the vehicle with respect to the object.

7. The vehicle guidance system of claim 1, further comprising a control box, the control box coupled to the vehicle.

8. The vehicle guidance system of claim 7, further comprising an extendable cable attached to the control box.

9. The vehicle guidance system of claim 8, further comprising an encoder interfacing with the cable, wherein the encoder detects a distance and a direction of the vehicle with respect to the object.

10. The vehicle guidance system of claim 9, further comprising logic configured to transmit information indicative of the detected distance and direction to the receiver, wherein the receiver relays the information to the driver.

11. The vehicle guidance system of claim 8, further comprising:
a potentiometer for detecting a location of the vehicle with respect to the object based upon an angular displacement of the cable.

12. The vehicle guidance system of claim 11, further comprising logic configured to transmit data associated with the detected location of the vehicle to the receiver, wherein the receiver relays a command associated with the location.

13. The vehicle guidance system of claim 1, wherein the receiver is a radio located in a cabin of the vehicle.

14. The vehicle guidance system of claim 1, further comprising a manual remote, wherein the logic is further configured to determine information related to movement of the vehicle, based upon a user input.

15. A vehicle guidance method, comprising the steps of:
determining information related to how to steer a vehicle so as to align the vehicle with an object;
transmitting the information to a receiver; and
relaying the information to a driver of the vehicle.

16. The vehicle guidance method of claim 15, wherein the determining step further comprises the step of:
determining a distance from the vehicle to the object.

17. The vehicle guidance method of claim 15, wherein the determining step further comprises the step of:
determining a location of the object relative to the vehicle.

18. The vehicle guidance method of claim 15, wherein the relaying step further comprises the step of audibly relaying the information to the driver.

19. The vehicle guidance method of claim 15, wherein the relaying step further comprises the step of visually relaying the information to the driver.

20. The vehicle guidance method of claim 15, wherein the determining step further comprises the step of:
monitoring the movement and the number of rotations of a roller by an encoder; and
translating the movement and number of rotations into a distance and direction.

21. The vehicle guidance method of claim 20, further comprising the step of transmitting information relative to the distance and the direction to the receiver.

22. The vehicle guidance method of claim 21, further comprising the step of relaying the distance and direction to the driver.

23. The vehicle guidance method of claim 15, further comprising the step of detecting a location of the vehicle with respect to the object based upon an angular displacement of a cable coupled to the vehicle and the object.

24. The vehicle guidance method of claim 23, further comprising the step of transmitting data associated with the detected angular location of the vehicle to the receiver.

25. The vehicle guidance method of claim 24, further comprising the step of relaying information indicative of the detected angular location to the driver.

26. The vehicle guidance method of claim 15, wherein the determining step further comprises the step of determining the information based upon a user input from a manual remote.

27. A vehicle guidance system, comprising:
a transmitter for transmitting to a receiver information related to a movement of a vehicle;
means for determining how to steer a vehicle so as to align the vehicle with an object; and
means for providing information corresponding to how to steer the vehicle to the transmitter.
